(19) United States
(12) Patent Application Publication
(10) Pub. No.: US 2021/0124334 A1
(43) Pub. Date: Apr. 29, 2021

(54) 3D PRINTABLE HOUSING ADAPTORS FOR VEHICLE SENSORS

(71) Applicant: Toyota Motor Engineering & Manufacturing North America, Inc., Plano, TX (US)

(72) Inventor: Ethan W. Pomish, Livonia, MI (US)

(73) Assignee: Toyota Motor Engineering & Manufacturing North America, Inc., Plano, TX (US)

(21) Appl. No.: 16/664,140

(22) Filed: Oct. 25, 2019

(51) Int. Cl. G05B 19/4099; G06Q 10/00; G06F 16/2455

(52) U.S. Cl. CPC G05B 19/4099; G05B 2219/49007; G06F 16/2455; G06Q 10/20

(57) ABSTRACT

A system for providing a housing adaptor for attaching a vehicle part to a vehicle. The system includes a 3D printer configured to receive a design and print the housing adaptor based on the design and an electronic controller communicatively coupled to the 3D printer. The electronic controller is programmed to provide an interactive interface configured to receive an input from a user and receive the input from the user, where the input comprises identification of a vehicle and the vehicle part to be installed on the vehicle. The electronic controller further determines the housing adaptor for coupling the vehicle part to the vehicle, where the determined housing adaptor corresponds to a housing adaptor model for printing on the 3D printer and transmits the housing adaptor model to the 3D printer, where the 3D printer prints the housing adaptor based on the received housing adaptor model.

### TECHNICAL FIELD

The present specification generally relates to systems and methods for on demand servicing of vehicle components using 3D printable materials. More specifically, the present specification relates to systems and methods of 3D printing housing adaptors and/or vehicle components at a service center to service a vehicle on demand.

### BACKGROUND

As vehicle technology advances, the number of sensors and electronic systems integrated within a vehicle continues to increase. From time to time, vehicle sensors may need to be replaced because of damage incurred to the sensor, an upgraded sensor or sensor package is available, defective sensors may need to be replaced, and/or new electronic systems may be available for a vehicle. Furthermore, the sensors and electronic systems that are integrated with a vehicle are generally coupled to the vehicle via a housing adaptor such as a customized fastening system. When a replacement, repair, upgrade, or addition of a sensor or electronic system is needed, a service center must order the specific components and housing adaptors required to complete the repair since the components (e.g., sensors and electronic systems) and their corresponding housing adaptors are designed for a particular year, make, model, and/or trim package of a vehicle. As a result, the vehicle owner and service center has to wait for a period of time until the components are delivered, which can be inconvenient and may result in added expenses for vehicle storage, rental vehicles, and/or the like.

### SUMMARY

In one embodiment, a system for providing a housing adaptor for attaching a vehicle part to a vehicle includes a 3D printer configured to receive a design and print the housing adaptor based on the design and an electronic controller communicatively coupled to the 3D printer. The electronic controller is programmed to provide an interactive interface configured to receive an input from a user and receive the input from the user, where the input includes identification of a vehicle and the vehicle part to be installed on the vehicle. The electronic controller further determines the housing adaptor for coupling the vehicle part to the vehicle, where the determined housing adaptor corresponds to a housing adaptor model for printing on the 3D printer and transmits the housing adaptor model to the 3D printer, where the 3D printer prints the housing adaptor based on the received housing adaptor model.

In some embodiments, a method for providing a housing adaptor for attaching a vehicle part to a vehicle includes providing, with an electronic controller, an interactive interface configured to receive an input from a user and receiving, with the electronic controller, the input from the user, where the input includes identification of a vehicle and the vehicle part to be installed on the vehicle. The method further includes determining, with the electronic controller, the housing adaptor for coupling the vehicle part to the vehicle, where the determined housing adaptor corresponds to a housing adaptor model for printing on the 3D printer and transmitting, with the electronic controller to a communicatively coupled 3D printer, the housing adaptor model to the 3D printer, where the 3D printer prints the housing adaptor based on the received housing adaptor model.

In some embodiments, a system for providing a housing adaptor for attaching a vehicle part to a vehicle includes a user computing device having a display communicatively coupled to a network, a 3D printer configured to receive a design and print the housing adaptor based on the design, and an electronic controller communicatively coupled to the 3D printer and to the network. The electronic controller provides, with the electronic controller, an interactive interface configured to receive an input from a user and receives, by the electronic controller from the user computing device, the input from a user, wherein the input includes identification of a vehicle and the vehicle part to be installed on the vehicle. The electronic controller further determines, with the electronic controller, the housing adaptor for coupling the vehicle part to the vehicle, where the determined housing adaptor corresponds to a housing adaptor model for printing on the 3D printer and transmits, with the electronic controller, the housing adaptor model to the 3D printer. The 3D printer prints the housing adaptor based on the received housing adaptor model.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an illustrative system for providing a housing adaptor for attaching a vehicle part to a vehicle according to one or more embodiments shown and described herein;

FIG. 2 depicts another illustrative system having an electronic controller for providing a housing adaptor for attaching a vehicle part to a vehicle according to one or more embodiments shown and described herein;

FIG. 3 depicts a flow diagram of an illustrative method for providing a housing adaptor for attaching a vehicle part to a vehicle according to one or more embodiments shown and described herein; and

FIG. 4 depicts an illustrative interactive interface for providing to a user according to one or more embodiments shown and described herein.

### DETAILED DESCRIPTION

Embodiments disclosed herein relate to systems and methods for providing on-demand and onsite vehicle sensor and electronic system replacement, repair, upgrade, or addition at a service center. More specifically, the present disclosure describes systems and methods that utilize three-dimensional (3D) printing to reduce the wait time for delivery of specialized housing adaptors or other vehicle components so that service to a vehicle may be performed more timely and such that the service is completed at a lower overhead cost to a service center. For example, it is contemplated that service centers implementing the systems and methods described herein may not need to order housing adaptors or other vehicle components because they may be readily selected, adapted, and manufactured onsite at the service center. That is, a vehicle owner or vehicle technician may select a sensor, electronic component, or electronic system for installation in a vehicle and the systems and methods described herein may determine the design, type, and other specifications for the housing adaptor or other vehicle parts needed to fit the selected component to the vehicle. The 3D printable designs for the housing adaptors and/or vehicle parts may be routed to a 3D printer located at a service center and may be automatically created for installation on the vehicle. The term “vehicle part” referenced herein may comprise sensors, electrical components, electronic systems, or other replaceable vehicle components,

Embodiments of the present disclosure also include processes and/or software applications implemented by the at least one system described herein. For example, applications may provide an interface with a user, access or contain three-dimensional (3D) models of various adaptors for printing, determine the specifications or 3D model required to mate a selected sensor and/or electronic component to a particular vehicle and the like. The processes and software applications improve the ability to quickly and efficiently access, order, and install new vehicle parts on a vehicle. Moreover, the present disclosure facilitates accessibility and installation of the vehicle part by readily storing 3D models of the adaptors that receive the vehicle part on the vehicle so the adaptors may be immediately printable by a 3D printer at a service center.

It is contemplated, for example, that a vehicle body of the present disclosure includes a one or more openings thereon that are sized and shaped to receive sensors and adaptor housings therein. A dealership or service center has one or more 3D printer systems located onsite. The system disclosed herein may include a catalog of 3D components (e.g., sensors and/or electronic components) from the OEM (original equipment manufacturer). When a customer requires a vehicle part (e.g., a sensor device), the customer may search the catalog and select the required vehicle part directly from the catalog. Through the selection of a part within the catalog, the system may determine the necessary housing adaptor and/or other vehicle components required for installing the selected vehicle part to the vehicle. The 3D model for the housing adaptor may be sent to an onsite 3D printer and printed so the housing adaptor does not need to be kept in stock or ordered. Such a system may allow service centers the flexibility of maintaining a stock of sensors or other electronic components that may be installed on numerous vehicles and not necessarily the various number of housing adaptors required for installing the sensors or other electronic components on one of many different vehicles. In other words, a sensor may be utilized on a number of vehicle makes, models, years, and/or trim packages. However, the sensor may be installed on each of the various number of vehicles through a different housing adaptor due to differences in, for example, the color of the vehicle, the trim package, the location of the sensor on the vehicle or the like.

As such, the dealership and the customer need not wait for the housing adaptor for the vehicle part to be delivered down the supply chain and to the service center location for installation onto the customer's vehicle. Rather, the housing adaptor for the vehicle part is printed onsite at the service center and optionally customizable to fit a particular vehicle make, model, year, and/or trim package.

The following will now describe these systems and methods in more detail with reference to the drawings and where like numbers refer to like structures.

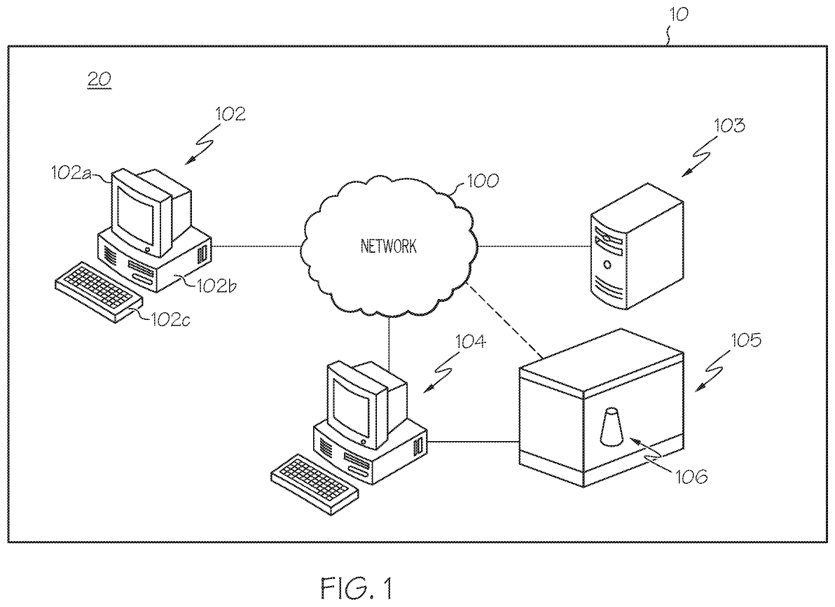

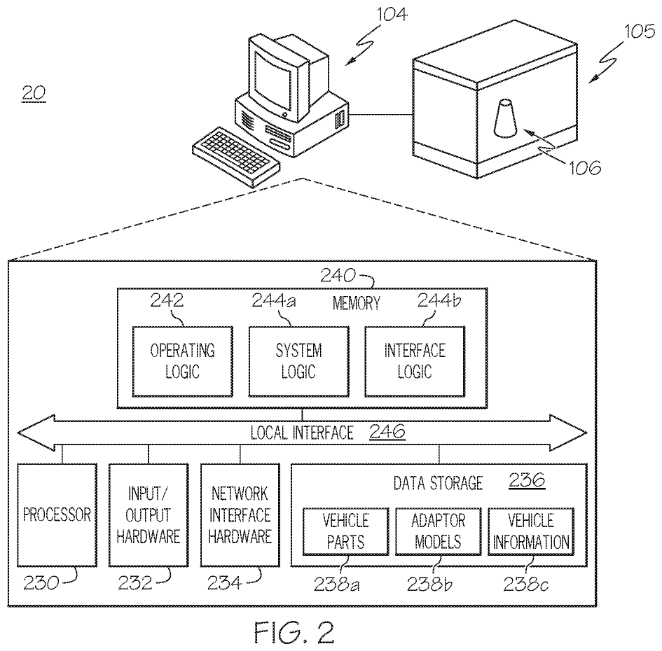

Referring to FIGS. 1 and 2, illustrative systems and computing devices configured to provide on-demand servicing of a vehicle using 3D printable materials are depicted. In other words, FIGS. 1 and 2 depict a system 20 for providing a housing adaptor for attaching a vehicle part to a vehicle. In particular, FIG. 1 depicts one example system implemented over a network of devices to provide on-demand servicing of a vehicle using 3D printable materials. The system of FIG. 1 may be implemented over a network 100. The network 100 may include a wide area network, such as the internet, a local area network (LAN), a mobile communications network, a public service telephone network (PSTN) and/or other network. The network 100 may be configured to electronically and/or communicatively connect a user computing device 102, one or more data servers 103 optionally storing one or more databases having housing adaptor models, vehicle configurations, vehicle parts including sensor and electronic system packages available for particular vehicles and/or the like, and an electronic controller 104. A three-dimensional (3D) printer 105 for on-demand creation of a housing adaptor 106 is included in the system and is communicatively coupled to the network 100 and/or the electronic controller 104. In some embodiments, the system 20 may be collocated or located within a service facility 10. In some embodiments, only one or more of the components of the system 20 may be collocated or located within the service facility 10. However, in such embodiments, the 3D printer is at least collocated or located within the service facility 10.

The user computing device 102 may include a display 102a, a processing unit 102b and an input device 102c, each of which may be communicatively coupled together and/or to the network 100. The user computing device 102 may be a server, a personal computer, a laptop, a tablet, a smartphone, a handheld device, or the like. The user computing device 102 may be used by a user of the system to provide information to the system. For example, the user may be a vehicle owner, a service technician, a fleet manager, or other vehicle service personnel. The user computing device 102 may utilize a local application or a web application to access the service system enabled by the electronic controller 104 as described herein. The electronic controller 104 may host and provide an interactive interface to the user computing device 102 such that a user may query, select, and/or input information that may be relayed to the electronic controller 104. The system may also include one or more data servers 103 having one or more databases from which information may be queried, extracted, updated, and/or utilized by the electronic controller 104.

Additionally, the system includes an electronic controller 104. The electronic controller 104 may be a server, a personal computer, a laptop, a tablet, a smartphone, an application specification handheld device, or the like. The electronic controller 104 may include a display and an input device each of which may be communicatively coupled together. The electronic controller 104, which is described in more detail herein, may be configured to host applications and execute processes related to the system described herein. It should be understood that while a user computing device 102 and one or more data servers 103 are depicted in the illustrative system of FIG. 1, each of the functions and operations performed by the user computing device 103 and one or more data servers 103 may be embodied and configured by the electronic controller 104.

It is also understood that while the user computing device 102 and the electronic controller 104 are depicted as personal computers and the one or more data servers 103 is depicted as a server, these are merely examples. More specifically, in some embodiments, any type of computing device (e.g., mobile computing device, personal computer, server, and the like) may be utilized for any of these components. Additionally, while each of these computing devices is illustrated in FIG. 1 as a single piece of hardware, this is also an example. More specifically, each of the user computing device 102, the one or more data servers 103, and the electronic controller 104 may represent a plurality of computers, servers, databases, and the like. For example, each of the user computing device 102, the one or more data servers 103, and the electronic controller 104 may form a distributed or grid-computing framework for implementing the methods described herein.

The 3D printer 105 may be any rapid-prototyping, rapid manufacturing device, or additive manufacturing device such as fused deposition modeling (FDM), stereolithography (SLA), digital light processing (DLP), selective laser sintering (SLS), selective laser melting (SLM), laminated object manufacturing (LOM), electron beam melting (EBM), and/or the like. The 3D printer 105 may include a processor and memory and other electronic components for receiving a housing adaptor model of a housing adaptor 106 for printing. The housing adaptor model is a design configuration file corresponding to housing adaptor for printing that may be uploaded to the 3D printer 105. As used herein, the “housing adaptor 106” refers to any vehicle part capable of receiving a sensor, electrical component, or electrical system and mounting or fastening the vehicle part to a vehicle. Moreover, as used herein “vehicle part” refers to a sensor, electrical component, or electrical system. In some embodiments, a vehicle body may have a universal type of receptacle for receiving a corresponding housing adaptor 106. In some embodiments, the housing adaptor 106 may be designed to receive the vehicle part and have a mounting or fastening structure that is unique and corresponds to the vehicle for which the vehicle part is to be installed on,

In some embodiments, the system may be implemented through the interconnectivity of multiple devices as depicted in FIG. 1. In other embodiments, the system is implemented through an electronic controller 104 communicatively coupled to the 3D printer 105. Regardless of the implementation of the system, FIG. 2 depicts an illustrative electronic controller 104. The electronic controller 104 may utilize hardware, software, and/or firmware, according to embodiments shown and described herein. While in some embodiments, the electronic controller 104 may be configured as a general-purpose computer with the requisite hardware, software, and/or firmware, in some embodiments, the electronic controller 104 may be configured as a special purpose computer designed specifically for performing the functionality described herein.

As illustrated in FIG. 2, the electronic controller 104 includes a processor 230, input/output hardware 232, network interface hardware 234, a data storage component 236, which may store a database of vehicle parts 238a, a database of adaptor models 238b, and/or vehicle information 238c, and a memory component 240. The memory component 240 may be machine readable memory (which may also be referred to as a non-transitory processor readable memory). The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242, system logic 244a for implementing one or more of the methods described herein, and interface logic 244b for implementing one or more of the interactive interfaces described herein (each of which may be embodied as a computer program, firmware, or hardware, as an example). A local interface 246 is also included in FIG. 2 and may be implemented as a bus or other interface to facilitate communication among the components of the electronic controller 104,

The processor 230 may include any processing component(s) configured to receive and execute programming instructions (such as from the data storage component 236 and/or the memory component 240). The instructions may be in the form of a machine readable instruction set stored in the data storage component 236 and/or the memory component 240. The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, Wi-Fi card, WiMax card, mobile communications hardware, and/or other hardware for communicating with other networks and/or devices.

It should be understood that the data storage component 236 may reside local to and/or remote from the electronic controller 104 and may be configured to store one or more pieces of data for access by the electronic controller 104 and/or other components. As illustrated in FIG. 2, the data storage component 236 may store a database of vehicle parts 238a, a database of adaptor models 238b, and/or vehicle information 238c. The database of vehicle parts 238a may include lists of sensors, electrical components, and/or electrical systems. The database of vehicle parts 238a may be standard components for a vehicle, optional upgrades, interchangeable models, and/or the like. The vehicle parts in the database of vehicle parts 238a may be associated with compatible vehicle information 238c. Moreover, the vehicle parts in the database of vehicle parts 238a may be associated with one or more adaptor models in the database of adaptor models 238b that are further associated with a vehicle make, vehicle model, vehicle year, vehicle trim package, and/or the like for which they capable of mounting or fastening a vehicle part to. The data stored in the database of vehicle parts 238a may be a list of vehicle parts, a lookup table of vehicle parts associated with specific vehicle information, or the like.

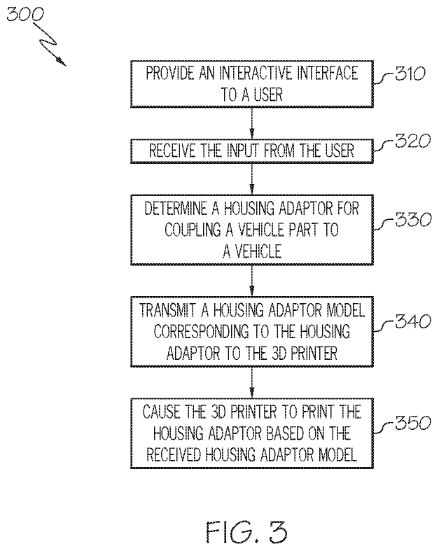

The database of adaptor models 238b include one or more housing adaptors models, for example, 3D modeling (CAD) files. From time to time the database of adaptor models 238b is updated with new or updated housing adaptor models that enable a vehicle part to be compatible with a vehicle make, vehicle model, vehicle year, vehicle trim package, and/or the like. The vehicle information 238c is a dataset of known vehicle makes, vehicle models, vehicle years, vehicle trim packages, and/or vehicle identification number. The vehicle information 238c, database of vehicle parts 238a, and database of adaptor models 238b may be cross-referenced with each other such that selection of an entry in one database narrows the selectable options from the other two datasets. For example, an input that identifies a vehicle make, model, and trim package may cause the electronic controller 104 to query the other two databases for vehicle parts and housing adaptor models compatible with the identified vehicle make, model, and trim package. Furthermore, a selection of a vehicle part, optionally for replacement, may cause the electronic controller to determine which housing adaptor model is needed to couple the selected vehicle part to the identified vehicle. Methods implemented by the electronic controller 104 will now be described in more detail with respect to the flow diagram depicted in FIG. 3.

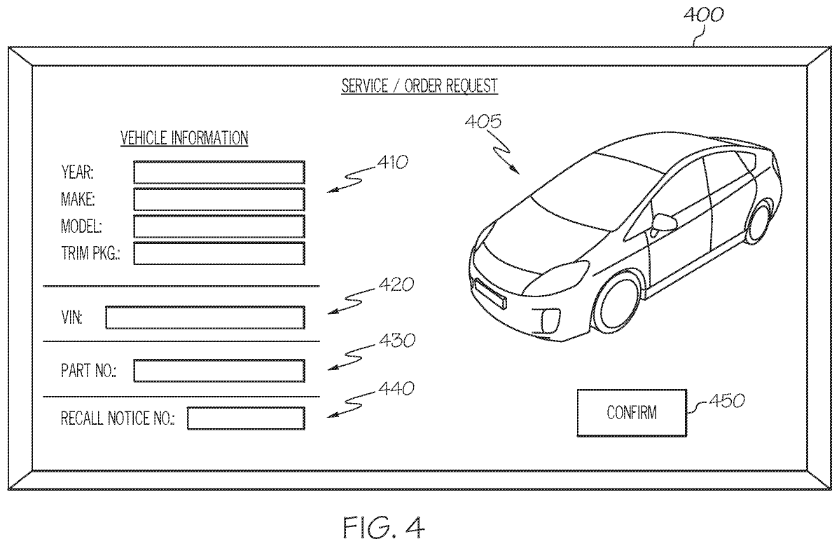

FIG. 3 depicts a flow diagram 300 of a method for providing a housing adaptor for attaching a vehicle part to a vehicle. The method depicted in the flow diagram 300 may be implemented by the electronic controller (e.g., the electronic controller 104, FIGS. 1 and 2) and/or other components of the system described herein. However, for purposes of description and simplification the method will be described with reference to the electronic controller 104. At block 310, the electronic controller 104 provides an interactive interface to a user. The interactive interface is configured to enable the user to input information regarding the vehicle make, model, year, trim package, vehicle identification number and/or the like. The interactive interface may also be programmed to enable a user to input a vehicle part for servicing. An example of the interactive interface will be described in more detail with respect to FIG. 4. Still referring to FIGS. 1 and 3, the electronic controller 104 may provide the interactive interface to a display communicatively coupled to the electronic controller 104, a display 102a of a user computing device 102 or another communicatively coupled display.

At block 320, the electronic controller receives one or more inputs provided by the user through the interactive interface. The one or more inputs may include identification information of a vehicle for service and the vehicle part to be installed on the vehicle for service. Identification of the vehicle for service may be provided in one or more ways. For example, the vehicle year, vehicle make, vehicle model, vehicle trim package, and/or the like may be specified. In some embodiments, a vehicle identification number (VIN) may be input where the VIN corresponds to a specific vehicle and vehicle specification information accessible or stored by the system. In some instances, a recall or predefined service number may be received that identifies the vehicle for service and/or the vehicle part for installation on the vehicle for service. The recall or predefined service number may identify a bill of materials including the housing adaptor model for fulfilling the recall or service request. Regarding the vehicle part, information identifying the vehicle part may be provided through reference to a model or serial number of the part, a description of the vehicle part, through selection of a picture of the part, or selection of the part through an interactive model of the vehicle, and/or by similar means.

At block 330, the electronic controller 104 utilizes the received information to determine the appropriate housing adaptor for coupling the vehicle part to the vehicle for service. Determination of the appropriate housing adaptor may include determining the specific housing adaptor model, which defines a design file for a 3D printer. In some embodiments, the determination made by the electronic controller 104 may further include determining the material, the color, and/or the like for the housing material such that the housing adaptor matches the vehicle for service and securely couples the vehicle part to the vehicle. More specifically, in embodiments, the housing adaptor is specific to the vehicle, location of the vehicle, vehicle trim package, and sensor (or vehicle part). By having an adaptor that is specifically designed and made for receiving a particular sensor and a specific vehicle, the same sensor may be installed on a variety of different vehicles by way of the customized housing adaptor. Moreover, the same sensor might need a different adaptor for different locations or different vehicles. Due to the variability in the combinations of sensors, vehicles (make, model, year trim package), and install locations on a vehicle, the ability to make a specific housing adaptor for receiving the particular sensor and the specific vehicle and location enables a service center to avoid stocking or having to order unnecessary housing adaptors. Instead, a service center may make the specific housing adaptor that is required to complete the install through the systems and methods described herein.

At block 340, once the electronic controller 104 has determined the housing adaptor needed to complete the vehicle part installation on the identified vehicle for service, the housing adaptor model may be transmitted to a 3D printer, Upon receipt of the housing adaptor model or at a predefined time communicated with the transmission of the housing adaptor model to the 3D printer, the 3D printer at block 350 prints the housing adaptor corresponding to the housing adaptor model. In embodiments contemplated herein, the 3D printer is located at a service center or a local parts distributor that provides vehicle parts and related materials to a service center to complete work on a vehicle. As such, a need for waiting for a customized housing adaptor may be reduced or eliminated since the housing adaptor may be made local with respect to the service center preforming work on the vehicle for service.

It should be understood that steps of the aforementioned process may be omitted or performed in a variety of orders while still achieving the object of the present disclosure. The functional blocks and/or flowchart elements described herein may be translated onto machine-readable instructions. As non-limiting examples, the machine-readable instructions may be written using any programming protocol, such as: descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

Turning now to FIG. 4, an example interactive interface 400 for display on a display device is depicted. The interactive interface 400 is only one example and other layouts and functionality may be implemented through other interactive interfaces. The interactive interface 400 as depicted includes one or more text boxes and/or drop down style data entry fields. These data entry fields may include fields for entering vehicle information 410, a VIN 420, a vehicle part number 430 or other method of identification of a vehicle part, and/or a recall or service notice number 440.

In some embodiments, the interactive interface 400 may include a virtually interactive model 405 of the vehicle for service. The virtually interactive model 405 may be an image, CAD model, or other similar rendering of the vehicle identified through the vehicle information 410. The model may automatically update in response to entry of vehicle information 410 into the corresponding data entry fields. A user may use a mouse or a touch-enabled device such as a stylus or finger to select a portion of the vehicle depicted by the virtually interactive model 405. Selection a portion of the vehicle causes the electronic controller 104 to either present vehicle parts associated with the selection that may be serviced or if the selection is defined with enough precision such that only one vehicle part is selected then the vehicle part information may be populated in the interactive interface. The interactive interface may also be used to indetify the location on the vehicle where the sensor is to be installed in situations where the same sensor may be installed in multiple locations on the vehicle.

In some embodiments, the virtually interactive model 405 may be further updated to highlight a portion of the vehicle where the selected vehicle part as identified by entry in the vehicle part number 430 field exists. This may assist a user in assuring they have selected the correct part for servicing. Furthermore, an assembly image or model of the vehicle part and/or housing adaptor may presented as the virtually interactive model 405 in place of the vehicle model.

Once the user has entered the necessary information for requesting service or placing ami order for a vehicle to be serviced, they may select a confirm button 450 to submit the information. For example, selection of the confirm button 450 causes the information entered in the interactive interface 400 to be sent to the electronic controller 104 for further processing, for example, as described with reference to block 320 in FIG. 3.

It should now be understood that embodiments described herein are directed to systems and methods for providing a housing adaptor for attaching a vehicle part to a vehicle. More specifically, the present disclosure facilitates accessibility and installation of the vehicle part by readily storing 3D models of the housing adaptors and printing the housing adaptors that receive the vehicle part. That is, service centers may avoid maintaining an inventory of the numerous varieties of housing adaptors or having to order them when needed, but rather have the convenience and ability to immediately print a housing adaptor required for service of a vehicle at the service center.

In some embodiments, a system includes a 3D printer configured to receive a design and print the housing adaptor based on the design and an electronic controller communicatively coupled to the 3D printer. The electronic controller may be configured to provide an interactive interface configured to receive an input from a user and receive the input from the user, where the input includes identification of a vehicle for service and the vehicle part to be installed on the vehicle for service. The electronic controller may further determine the housing adaptor for coupling the vehicle part to the vehicle for service, where the determined housing adaptor corresponds to a housing adaptor model for printing on the 3D printer and transmit the housing adaptor model to the 3D printer. The 3D printer may print the housing adaptor based on the received housing adaptor model. In such embodiments, the 3D printer may be located locally at a service center or nearby such as at a parts distributor such that a wait time for receiving materials from a manufacturer may be reduced or eliminated.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for providing a housing adaptor for attaching a vehicle part to a vehicle, the system comprising:
a 3D printer configured to receive a design and print the housing adaptor based on the design; and
an electronic controller communicatively coupled to the 3D printer, wherein the electronic controller is programmed to:
provide an interactive interface configured to receive an input from a user;
receive the input from the user, wherein the input comprises identification of a vehicle and the vehicle part to he installed on the vehicle;
determine the housing adaptor for coupling the vehicle part to the vehicle, wherein the determined housing adaptor corresponds to a housing adaptor model for printing on the 3D printer; and
transmit the housing adaptor model to the 3D printer, wherein the 3D printer prints the housing adaptor based on the received housing adaptor model.

2. The system of claim 1, wherein the electronic controller is further programmed to:
receive a location on the vehicle for installing the vehicle part; and
determine the housing adaptor based on the location.

3. The system of claim 1, wherein the interactive interface provides the user access to a database of vehicle parts comprising the vehicle part.

4. The system of claim 3, wherein the database of vehicle parts includes at least one of a sensor or electrical component.

5. The system of claim 1, wherein the interactive interface provides an input field for selecting or inputting vehicle information including at least one of a vehicle make, a vehicle model, a vehicle year, a vehicle trim package, or a vehicle identification number, wherein the vehicle information narrows a database of vehicle parts to a set of vehicle parts that are compatible with the received vehicle information.

6. The system of claim 5, wherein the interactive interface includes an interactive image of the vehicle based on the vehicle information such that the user may select a portion of the vehicle model visualized via the interactive interface to select the vehicle part.

7. The system of claim 1, wherein the input includes a recall number or a service number that corresponds to a bill of materials including the housing adaptor for fulfilling the recall or service request.

8. A method for providing a housing adaptor for attaching a vehicle part to a vehicle, the method comprising:
providing, with an electronic controller, an interactive interface configured to receive an input from a user;
receiving, with the electronic controller, the input from the user, wherein the input includes identification of a vehicle and the vehicle part to be installed on the vehicle;
determining, with the electronic controller, the housing adaptor for coupling the vehicle part to the vehicle, wherein the determined housing adaptor corresponds to a housing adaptor model for printing on the 3D printer; and
transmitting, with the electronic controller to a communicatively coupled 3D printer, the housing adaptor model to the 3D printer, wherein the 3D printer prints the housing adaptor based on the received housing adaptor model.

9. The method of claim 8, further comprising:
receiving a location on the vehicle for installing the vehicle part; and
determining the housing adaptor based on the location.

10. The method of claim 8, wherein the interactive interface provides the user access to a database of vehicle parts comprising the vehicle part.

11. The method of claim 10, wherein the database of vehicle parts includes at least one of a sensor or electrical component.

12. The method of claim 8, wherein the interactive interface provides an input field for selecting or inputting vehicle information including at least one of a vehicle make, a vehicle model, a vehicle year, a vehicle trim package, or a vehicle identification number, wherein the vehicle information narrows a database of vehicle parts to a set of vehicle parts that are compatible with the received vehicle information.

13. The method of claim 12, wherein the interactive interface includes an interactive image of the vehicle based on the vehicle information such that the user may select a portion of the vehicle model visualized via the interactive interface to select the vehicle part.

14. The method of claim 8, wherein the input includes a recall number or a service number that corresponds to a bill of materials including the housing adaptor for fulfilling the recall or service request.

15. A system for providing a housing adaptor for attaching a vehicle part to a vehicle comprising:
a user computing device having a display communicatively coupled to a network;
a 3D printer configured to receive a design and print the housing adaptor based on the design; and
an electronic controller communicatively coupled to the 3D printer and to the network, wherein the electronic controller:
provides, with the electronic controller, an interactive interface configured to receive an input from a user;
receives, by the electronic controller from the user computing device, the input from the user, wherein the input includes identification of a vehicle and the vehicle part to be installed on the vehicle;
determines, with the electronic controller, the housing adaptor for coupling the vehicle part to the vehicle, wherein the determined housing adaptor corresponds to a housing adaptor model for printing on the 3D printer; and
transmits, with the electronic controller, the housing adaptor model to the 3D printer,
wherein the 3D printer prints the housing adaptor based on the received housing adaptor model.

16. The system of claim 15, wherein the electronic controller further:
receives a location on the vehicle for installing the vehicle part; and
determines the housing adaptor based on the location.

17. The system of claim 15, wherein the interactive interface provides the user access to a database of vehicle parts comprising vehicle parts.

18. The system of claim 17, wherein the database of vehicle parts includes at least one of a sensor or electrical component.

19. The system of claim 15, wherein the interactive interface provides an input field for selecting or inputting vehicle information including at least one of a vehicle make, a vehicle model, a vehicle year, a vehicle trim package, or a vehicle identification number, wherein the vehicle information narrows a database of vehicle parts to a set of vehicle parts that are compatible with the received vehicle information.

20. The system of claim 19, wherein the interactive interface includes an interactive image of the vehicle based on the vehicle information such that the user may select a portion of the vehicle model visualized via the interactive interface to select the vehicle part.
